(19) United States
(12) Patent Application Publication
(10) Pub. No.: US 2010/0303876 A1
(43) Pub. Date: Dec. 2, 2010

(54) METHOD FOR PREPARING SILVER NANOPARTICLES

(75) Inventors: Gerard Klein, Neuchatel (CH); Edouard Marc Meyer, Neuchatel (CH)

Correspondence Address: YOUNG & THOMPSON, 209 Madison Street, Suite 500, Alexandria, VA, 22314, US

(73) Assignee: METALOR TECHNOLOGIES INTERNATIONAL SA, Neuchatel (CH)

(21) Appl. No.: 12/675,894

(22) PCT Filed: Aug. 26, 2008
(86) PCT No.: PCT/EP2008/061142

§ 371 Date: Mar. 1, 2010

(30) Foreign Application Priority Data
Aug. 31, 2007 (EP) 07115455.3

(51) Int. Cl. A01N 25/04; A01P 1/00; H01B 1/22

(52) U.S. Cl. 424/405; 252/514

(57) ABSTRACT

The invention relates to a method for preparing silver nanoparticles having a diameter lower than 80 nm, and dispersed in a polymer matrix in a concentration higher than 1 M, that comprises the following steps: i) mixing an organic silver salt and a polymer having an alcohol terminal function in a solvent containing at least one alcohol fraction; ii) agitating and heating the mixture obtained during the previous step; and iii) separating the polymer phase charged with silver nanoparticles.

### TECHNICAL FIELD

The present invention relates to the field of nanotechnology. It more particularly relates to a method for preparing silver nanoparticles.

### STATE OF THE ART

Metal nanoparticles are widely studied for their optical, electrical, catalytic or even biological properties. The size and the shape of these particles considerably influence their characteristics. Many studies have been conducted in order to define methods with which the shape and the size of the different metal nanoparticles may be controlled accurately. Different preparation routes have been tested for this purpose, such as chemical reduction, gas condensation, laser irradiation . . . .

More specifically, silver particles have a significant advantage. First of all, their antimicrobial properties resulting from their interaction with thiol, amine, imidazole, carboxyl, or further phosphate functional groups of proteins from living organisms destine them to a large number of application in the medical field.

Moreover, when silver particles are dispersed in polymeric organic matrices, they may be used as a conductor in electronic and electrotechnical applications. This use is of interest for two reasons, on the one hand because the obtained conducting formulations may be partly transparent and on the other hand because it is possible to induce sintering between the particles in order to create a cross-linked metal assembly, the conducting properties of which are strongly enhanced.

Further, it is also important to stabilize formed particles, so that they do not agglomerate and that they keep their properties.

However, these investigations for the time being have only been undertaken experimentally and the reaction conditions cannot be transposed to industrialization.

For example, a synthesis route was proposed by Li and Al (J. Am. Chem. Soc. Vol. 127, No. 10, 2005), starting from silver acetate and an alkylamine, in toluene and phenylhydrazine. However, such a reaction cannot be used industrially for two major drawbacks. First of all, the use of a nitrogen-containing reducing agent is a nuisance for possible electronic applications of the obtained nanoparticles, because traces of nitrogen always subsist, which are detrimental for the quality of the obtained electronic device. Next, although the publication mentions that the product of the reaction has a high silver concentration, the latter is only 0.5 M. Now, such a concentration is not sufficiently high for such a synthesis being of interest economically. Indeed, significant volumes of reagents have to be applied in order to obtain a sufficient amount of nanoparticles.

Further, other standard routes for preparing silver by reduction of Ag+ ions generally involve reagents or toxic solvents (silver nitrate, DMF . . . ) and drastic reaction conditions (temperature, pressure), which no longer makes them solutions of choice for industrialization, because they are delicate in terms of safety and ecology. Finally, usual nucleation/growth processes lead to too big particles, which cannot be used for the targeted applications.

The object of the present invention is therefore to propose an easily industrializable synthesis route for silver nanoparticles, with which these particles may be obtained with good control of their size and of their shape.

### DISCLOSURE OF THE INVENTION

More specifically, the invention relates to a method for preparing silver nanoparticles with a diameter of less than 100 nm, dispersed in a polymeric matrix at a concentration above 1 M, including the following steps:
reacting a silver organic salt and a polymeric agent for nucleating and stabilizing silver nanoparticles,
mixing the reaction medium obtained previously with a reducing agent having a limited reduction potential, so as not to agglomerate the reduced silver, and having coordination affinity with Ag+ ions,
concentrating and separating the polymeric matrix containing the silver nanoparticles.

More particularly, the above method proves to be particularly advantageous when the applied silver organic salt is selected from silver acetate, silver acetylacetonate, silver citrate, silver lactate or silver pentafluoropropionate.

Very interesting results have been obtained by mixing the silver organic salt with a polymer based on polyvinylpyrrolidone (PVP), polyethyleneglycol (PEG) or based on polypropyleneglycol.

Thus, the method according to the invention does not involve any toxic or dangerous product for the environment. Further, the reaction conditions are mild and with them it is possible to limit to a maximum, the risks inherent to the reaction.

### SHORT DESCRIPTION OF THE DRAWINGS

Other characteristics of the method will become more clearly apparent upon reading the description which follows, accompanied by the appended drawing showing images obtained by transmission electron microscopy (TEM) of silver particles obtained according to the method.

### EMBODIMENT(S) OF THE INVENTION

The method for preparing silver nanoparticles according to the invention includes a first step for mixing 5 g of silver acetate with a solution of 5 g of polyvinylpyrrolidone (PVP) with a molecular mass of 10,000 in 200 mL of water at a temperature comprised between 40 and 60° C., typically 50° C. PVP is used as nucleation agent and as a stabilizer, in order to allow the formation of silver nanoparticles, while avoiding their agglomeration.

A rise in temperature is carried out within 5 minutes in order to reach a temperature comprised between 60 and 90° C., typically 75° C. The solution which is white at the beginning of the reaction, then changes to a brown odor. The reaction medium is then left under stirring for 45 minutes at 95° C. The solution then changes from a brown color to a green color. Heating is then stopped and the solution is left under stirring in order to reach 35° C.

The reaction medium is then mixed with a 20 mM ascorbic acid solution. Ascorbic acid is used as a reducing agent. It has coordination affinity with Ag⁺ ions, while having a limited reduction potential, so as not to agglomerate the reduced silver. Thus, ascorbic acid may, in a first phase, bind with Ag⁺ ions in a stable way, allowing transfer of electrons to occur in a second phase, without agglomeration of the silver particles. As an indication, the reduction potential of ascorbic acid is −0.41 V. Other reducing agents with a reduction potential of typically less than +0.2 V, preferably less than −0.2 V, but greater than −1.5 V, preferably greater than −1.2 V, preferably greater than −1 V, may be contemplated. It will be noted for example that glucose (reduction potential −1.87 V) is a too powerful reducing agent and reduces Ag⁺ ions but forms agglomerates thereof. The potentials above are given according to the usual standard in Europe and to extracts of the: CRC Handbook Series in Organic Electrochemistry, Vol. 1, 1976.

Continuous addition of the reaction medium and of the reducing agent in a stoichiometric proportion might also be contemplated.

When the reduction reaction is completed, i.e. typically after 30 minutes, the solution is centrifuged in order to concentrate the polymeric matrix containing the silver nanoparticles, it will be noted that the change in the reduction reaction may be tracked by UV/visible spectroscopy.

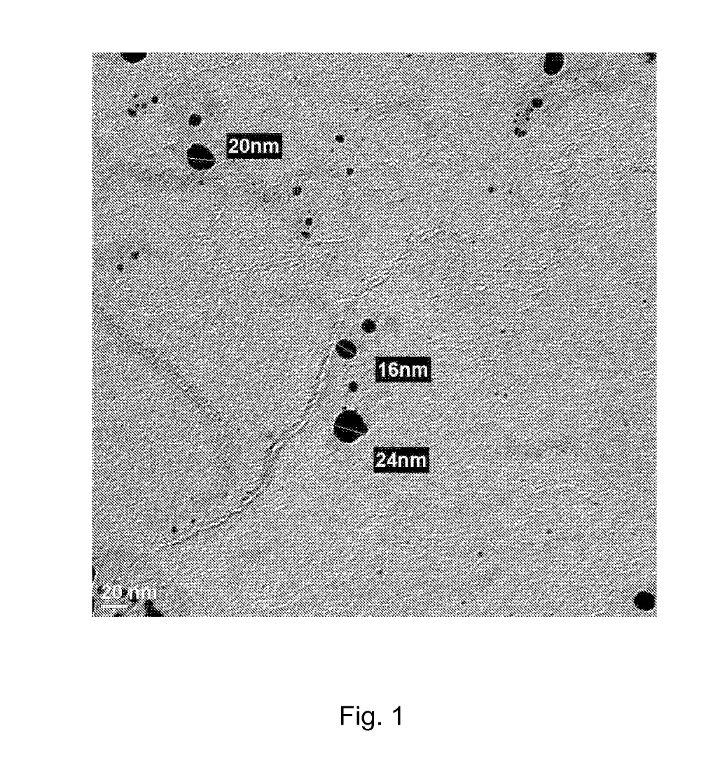

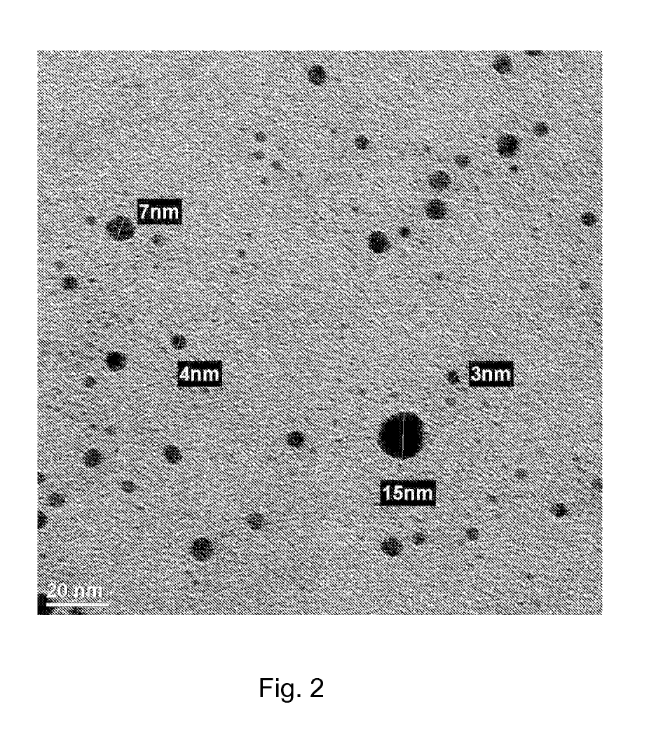

With the analysis carried out on the final product it may be determined that 80% of the silver introduced as silver acetate is converted into metal silver (Ago), FIGS. 1 and 2 are images obtained by transmission electron microscopy (TEM) with which the size of the nanoparticles and their distribution may be measured. The size of the obtained nanoparticles is comprised between 3 and 50 nm.

Other experiments were carried out with different organic salts of silver, such as diver acetylacetonate, silver citrate, silver lactate or silver pentafluoropropionate. Similarly, polyethylene glycol (PEG) and polypropylene glycol were also used as a replacement for PVP and these polymers may be applied with different molecular masses. For interpreting the claims, the term of polymer based on PVP, PEG or polypropylene glycol comprises copolymers having one of these monomers as a unit. Depending on the reagents used, the obtained silver nanoparticles have a diameter of less than 100 nm, more particularly less than 80 nm, more particularly less than 50 nm. Particles with a diameter dose to 2 nm were able to be detected. These particles are dispersed in the polymeric matrix at a concentration above 1 M, particularly above 2 M, most particularly above 3 M.

The obtained conversion rate on the one hand and the quality of the obtained particles (reduced size and uniformity of the dimensions) on the other hand, are remarkable as compared with other experimental methods.

As a comparison, mention may be made of another tested experimental procedure, including a first step for mixing 10 g of silver acetate and 1 g of polyethylene glycol with a molecular mass of 1,500 (PEG 1500) in 80 mL of tert-butanol at 50° C. The PEG is also used as a reducing agent. Silver acetate forms a suspension in the solution of alcohol and PEG. The mixture is stirred and its temperature is raised to about 75° C. over a period of 5 minutes. The solution is left under stirring for 45 minutes at 80° C. The best conversion rate obtained with this procedure is about 50%.

Thus, a method for preparing silver nanoparticles is proposed with which these particles may be obtained with good control of their size and of their shape. As regards industrialization, the different aforementioned reagents may be used and combined. However, the selection of silver acetate and of PVP seems to have the best combination in terms of yield, of quality of the obtained particles, of costs of the reagents, of safety of the reaction and of ecology.

1-9. (canceled)

10. A method for preparing silver nanoparticles with a diameter of less than 100 nm, dispersed in a polymeric matrix at a concentration above 1 M, including the following steps:
i. reacting an organic salt of silver and a polymeric agent for nucleating and stabilizing silver nanoparticles,
ii. mixing the reaction medium obtained earlier with a reducing agent having a defined reduction potential and having coordination affinity with Ag⁺ ions,
iii. concentrating and separating the polymer matrix containing the silver nanoparticles.

11. The method according to claim 10, wherein said organic salt of silver is selected from silver acetate, silver acetylacetonate, silver citrate, silver lactate or silver pentafluoropropionate.

12. The method according to claim 10, wherein the polymer is based on polyvinylpyrrolidone (PVP) or polyethylene glycol (PEG) or polypropylene glycol.

13. The method according to claim 11, wherein the polymer is based on polyvinylpyrrolidone (PVP) or polyethylene glycol (PEG) or polypropylene glycol.

14. The method according to claim 12, wherein the reacting step takes place in an aqueous medium.

15. The method according to claim 13, wherein the reacting step takes place in an aqueous medium.

16. The method according to claim 14, wherein step i. includes the addition of water at a temperature comprised between 40 and 60° C., a heating phase to a temperature comprised between 65 and 95° C. and a cooling phase.

17. The method according to claim 15, wherein step i. includes the addition of water at a temperature comprised between 40 and 60° C., a heating phase to a temperature comprised between 65 and 95° C. and a cooling phase.

18. The method according to claim 10, wherein the reducing agent used is ascorbic acid.

19. The method according to claim 10, wherein the concentration and separation operation is carried out by centrifugation.

20. The method according to claim 10, wherein the diameter of the silver nanoparticles obtained is less than 50 nm.

21. The method according to claim 10, wherein the silver nanoparticles obtained are dispersed in a polymeric matrix at a concentration above 2 M, preferably above 3 M.

22. The method according to claim 11, wherein the reducing agent used is ascorbic acid.

23. The method according to claim 12, wherein the reducing agent used is ascorbic acid.

24. The method according to claim 13, wherein the reducing agent used is ascorbic acid.

25. The method according to claim 14, wherein the reducing agent used is ascorbic acid.

26. The method according to claim 15, wherein the reducing agent used is ascorbic acid.

27. The method according to claim 16, wherein the reducing agent used is ascorbic acid.

28. The method according to claim 17, wherein the reducing agent used is ascorbic acid.

29. The method according to claim 11, wherein the concentration and separation operation is carried out by centrifugation.
